(19) United States
(12) Patent Application Publication
(10) Pub. No.: US 2003/0159145 A1
(43) Pub. Date: Aug. 21, 2003

(54) Device and method for automatically tuning to a certain data choice based on user content preferences

(76) Inventor: Louis Kaltz, Sicklerville, NJ (US)

Correspondence Address: RATNERPRESTIA, P O BOX 980, VALLEY FORGE, PA, 19482-0980, US

(21) Appl. No.: 10/076,805

(22) Filed: Feb. 15, 2002

(51) Int. Cl. H04N 5/445

(52) U.S. Cl. 725/46; 725/53

(57) ABSTRACT

A device automatically tunes to a viewer preferred data choice from among a plurality of available data choices. The device receives attribute content for a plurality of available data choices. The device includes a processor configured to enable a viewer to rank attribute preferences, compare the attribute content with the ranked attribute preferences, and automatically present the data choice with attribute content corresponding to the highest ranked attribute preference. The system is applicable to television receivers and radio receivers.

### BACKGROUND OF THE INVENTION

The present invention relates to tuning a receiver, and more particularly to a device and method for automatically tuning to a certain data choice among a plurality of available data choices based on user's content preferences.

Television viewers receive an ever increasing number of program choices encompassing terrestrial, cable, and satellite broadcasts with the coming of digital radio, the same will soon be true for radio transmissions. The number of choices makes the task of finding a preferred program more difficult and time-consuming. Similarly, the number of data choices for other media such as the Internet make selecting and tuning to a desired data choice difficult and time-consuming. A viewer may miss a preferred program or other data choice because he or she is unaware that the preferred program or data choice is available. Additionally, a first viewer, such as a parent, may wish to pre-select data choices for a second viewer, such as a child. To assist viewers in selecting a preferred program, various printed and electronic programming guides are provided. These programming guides can be helpful in determining the data choices available, but they do not automatically tune to a certain data choice based on user preferences.

Presently, a device and method are desired in which an individual can provide specific preferences, and have the device automatically tune to a data choice corresponding to the highest preference currently available.

### SUMMARY OF THE INVENTION

In the present invention, a device automatically tunes to a user preferred data choice from among a plurality of available data choices. The device receives attribute content for a plurality of available data choices. The attribute content can be received through a variety of interfaces. For example, the attribute content may be provided as a data choice on a specific channel or frequency. The device includes a processor configured to enable a user to rank attribute preferences, compare the attribute content for available data choices with the ranked attribute preferences, and automatically present the data choice with attribute content corresponding to the highest ranked attribute preference.

### BRIEF DESCRIPTION OF THE DRAWINGS

These and other features, aspects, and advantages of the present invention will become more fully apparent from the following description, appended claims, and accompanying drawings in which the same reference numerals are used for designating the same elements throughout the several figures, and in which:

FIG. 1 is a block diagram of a television system that includes an embodiment of the present invention;

FIG. 2 is a flow chart for a process to create a data-list comprising attribute preferences in ranked order for identifying data choices preferable to a viewer according to one embodiment of the present invention;

FIG. 3 is an exemplary first interface screen for selecting attribute preferences from a data-store of attribute content to create a data-list according to one embodiment of the present invention;

FIG. 4 is an exemplary second interface screen for ranking attribute preferences according to the embodiment of FIG. 3;

FIG. 5 is a flow chart for a process that automatically tunes to a data choice from among a plurality of data choices based on viewer preferences according to one embodiment of the present invention;

FIG. 6 is an exemplary representation of a data choice automatically tuned to from the plurality of data choices represented in the data-store of FIG. 3 based on user preferences according to the embodiment of FIG. 5;

FIG. 7 is another exemplary representation of data content in a data-store provided by an interface according to the exemplary embodiment of the present invention;

FIG. 8 is another exemplary representation of a data choice automatically tuned to from the plurality of data choices represented in the data-store of FIG. 7 based on user preferences;

FIG. 9 is a flow chart for a process that automatically tunes to a data choice from among a plurality of data choices based on viewer preferences incorporating a tie-breaking function according to one embodiment of the present invention; and

FIG. 10 is a flow chart for a process for automatically tuning to a data choice from among a plurality of data choices based on viewer preferences incorporating a block-out function according to one embodiment of the present invention.

### DESCRIPTION OF THE PREFERRED EMBODIMENT

While the present invention is described in terms of a television program selection system, it is equally applicable to other systems which include a variety of user selectable content, such as radio receivers that may receive digital radio transmissions.

Certain terminology used in the following description is for convenience only and is not limiting. The term “device” as used herein refers to any consumer electronic device that displays an active video signal and either stores data about that active video signal or has access to information for a plurality of available video signals. The term “data-store” as used herein refers to any data structure (e.g., database) that stores information to be retrieved at a later time. The term “data-list” refers to any list of individual unique data items of any size, shape or form. The term “data choice” as used herein refers to an available data file or data stream that can be displayed as a useable video signal, including, but not limited to television programs, computer files, and the like. The term “attribute” as used herein refers to a characteristic of a particular data choice or group of data choices, such as a program title, an actor appearing in a program, or a keyword describing a program genre or plot. The term “attribute content” as used herein refers to a data-store comprising attributes for available data choices. The term “attribute preference” as used herein refers to a data-list comprising attributes in ranked order from 1 to n based on viewer preference.

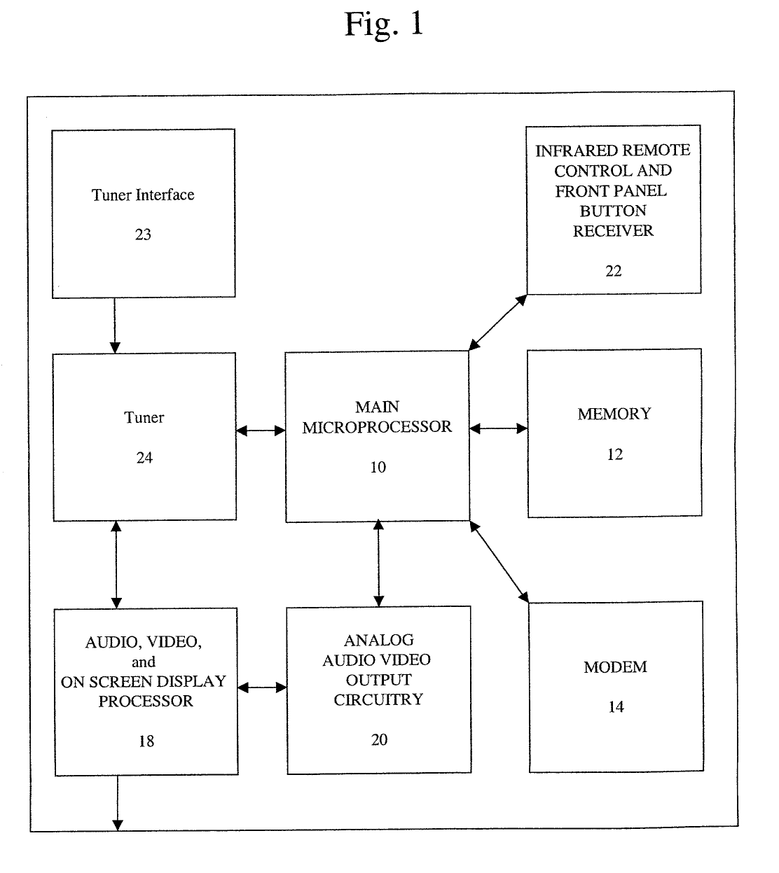

Referring to FIG. 1, the present invention is described in reference to television programs by way of illustration and is not intended to limit the present invention to this embodiment. To the contrary, the present invention can be practiced with a variety of data choices other than television programs, including but not limited to computer files. FIG. 1 is a block diagram of a television system that includes an embodiment of the present invention. The system is controlled by process code (e.g., computer instructions) executing on microprocessor 10. The microprocessor 10 may include a read only memory (ROM) encoded with program data, as well as a small random access memory (RAM) for operating data values. The microprocessor 10 is coupled to a memory 12 which, in the exemplary embodiment of the invention, may hold a database or data-store of attribute content for available programs and a ranked list of attribute preferences as a data-list. The data memory 12 may be implemented as RAM or as a mass storage medium such as a magnetic disk or non-volatile memory card.

Signals from terrestrial, cable, or satellite broadcast are received via tuner interface 23, which can be a UHF or VHF antenna, a cable connection, a satellite dish, or the like. The signals are transmitted to a tuner 24 which demodulates a signal at a selected frequency. Signals from a user interface are received via infrared remote control and front panel button receiver 22. Audio & Video data from tuner 24 is sent to the Audio, Video and On Screen Display processor 18. The processor 18 may, for example, decode the received audio and video data to provide digital audio and video output signals. The Audio and Video output signals may be provided to an output port as digital signals, or converted to the analog domain via Digital to Analog conversion in the Analog Audio Video Output Circuitry 20. The circuitry 20 may include, for example, a digital to analog converter (not shown), audio or video amplifiers (not shown), and tone, volume, color saturation, color hue, brightness, and contrast controls (not shown). A modem 14 may be connected to a telephony network, available at the location of the television system.

In the digital television system of FIG. 1, a program executing on microprocessor 10 receives user input from remote control and front panel receiver 22. The program then controls tuner 24 to select a desired frequency. The data signal transmitted at the selected frequency is then demodulated and sent to A/V processor 18, where, once decoded, it may be output digitally, or converted to an analog signal via analog output circuitry 20. Microprocessor 10 may also control the amplitude of the audio output signal emanating from analog audio video output 20 and may provide an on-screen display (ODS) video signal over, or in place of, the video signal from tuner 24. The ODS signal may be used to display control menu information or program guide information, as described below. In order to communicate with a service provider, the digital television system shown in FIG. 1 periodically makes outgoing calls via an integral telephony interface, modem 14. The modem 14 may be used, for example, to monitor the use of premium services, to order pay-per-view presentation, or as an interface to provide electronic program guide information to the system. Modem 14 is optional and is not required to practice the present invention.

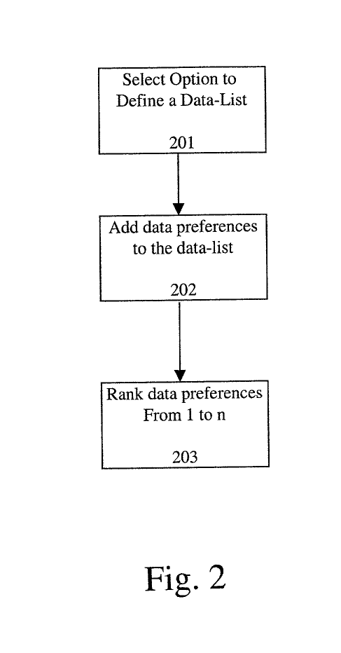

FIG. 2 is a flow diagram of a process for automatically tuning to a certain data choice from among a plurality of available data choices based on viewer preferences. First, a viewer defines a data-list by, for example, selecting items from a data-store (step 201). The data-store comprises attribute content information for a plurality of data choices. For example, the data choices in a particular data-store could be television programs. The items in the data-store may be attribute content for the television programs. The attribute content of a program may include, for example, the genre, title, actors' names, sports teams, and a plot summary (for key word searching). The attribute content selected to create the data-list are attribute preferences. In one embodiment, an interface screen is used to select attribute preferences to create a data-list. The data-store can be provided with data using any one of one or more various interfaces. For example, the data may be transmitted at a specific frequency and accessed through tuner (24 in FIG. 1) and tuner interface (23 in FIG. 1). Alternatively, the attribute data may be obtained from any of a number of commercially available electronic program guide (EPG) services, such as Starsight.

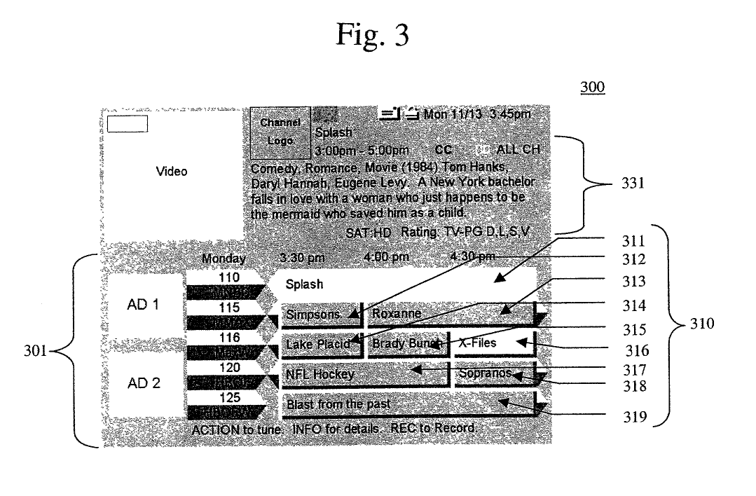

FIG. 3 is an exemplary first interface screen 300 for selecting attribute preferences to create a data-list. FIG. 3 is an on-screen display (OSD) of an electronic program guide database that may be stored in the memory 12, shown in FIG. 1 or accessed through an available interface, and used as a data-store. To simplify the description of the invention, the display shown in FIG. 3 and the data-store of available program content stored in the memory 12 or accessed through an interface are used interchangeably. In this example, program title is the only attribute used for selecting attribute preferences and a portion of a data-store is visually presented in an attribute content display 301 showing the attribute content for the attribute, program title, for each data choice available from 3:30 PM to 5:00 PM of a particular day. The attribute content display 301 in FIG. 3 comprises nine items of attribute content 310. Each item of attribute content 310 corresponds to a different data choice. The displayed data content items are the titles: Splash 311, Simpsons 312, Roxanne 313, Lake Placid 314, Brady Bunch 315, X-Files 316, NHL Hockey 317, Sopranos 318, and Blast from the Past 319. In the example illustrated in FIG. 3, the attribute content of the title Splash 311 corresponds to the data choice of the movie Splash. Similarly, the title Simpsons 312 corresponds to an episode of the program Simpsons which is another data choice. Items of attribute content can be selected for addition to an existing data-list or to create a new data list. The items of data content can be selected in one or more of a variety of ways. For example, a viewer may scroll through an attribute content display 301 in which successive attribute content 310 is highlighted and perform a select action on the highlighted item to add it to a data-list.

The device of the present invention can accommodate a plurality of data-lists. For example, a unique data-list can be provided for each of a plurality of viewers. Data-lists may be stored in the memory (12 in FIG. 1) or they can be stored externally and accessed through any interface. Each data-list may comprise attribute content for a single attribute, such as program title, or for multiple attributes. For example, additional attribute content 331 is provided for the movie Splash 311. Additional attribute content for other data choices may be accessed, for example, by scrolling through the various program tiles (311-319) displayed. In this example, additional attribute data can comprise, for example, genre of program, actors appearing in a program, a description of a program, starting and ending times, and a rating for a program.

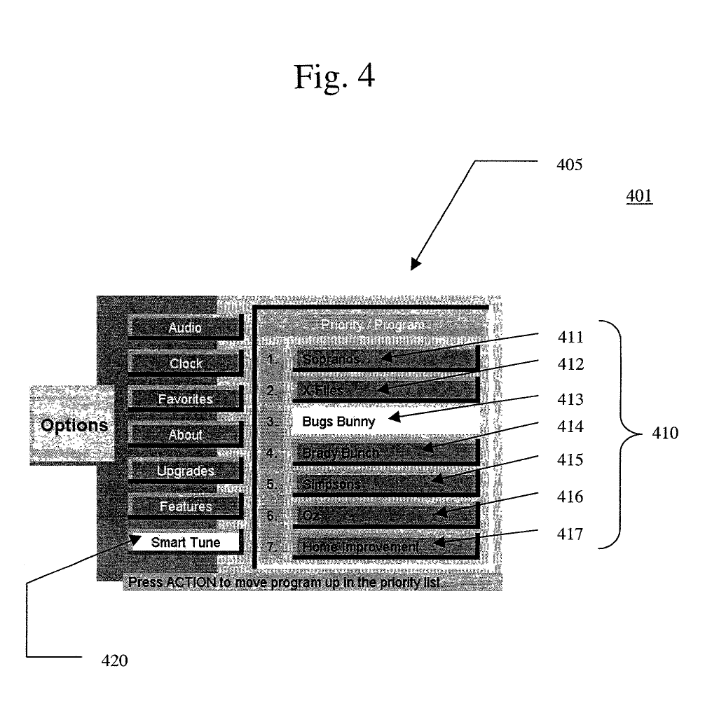

Referring again to FIG. 2, after attribute content is selected for inclusion in a data-list as attribute preferences, the attribute preferences are ranked in order of viewer preference (step 202). FIG. 4 is an exemplary second interface screen 401 for ranking attribute preferences according to the embodiment of FIG. 3. The attribute content selected above is stored in a data-list 405 as attribute preferences 410. The data list 405 may be stored in the memory 12, shown in FIG. 1. To simplify the description of the invention, the displayed data list 405 and the data-list stored in the memory 12 are used interchangeably. The attribute preferences 410 are ranked in order from 1 to n (where n is the total number of attribute preferences selected). In the example of FIG. 4, the highest ranked attribute preference is the show title Sopranos 411. Therefore, whenever an episode of the program Sopranos is broadcast, the present invention automatically tunes to that program. The second highest ranked attribute preference in the example of FIG. 4 is the show title X-Files 412. Therefore, whenever an episode of the program X-Files is broadcast, and there are no episodes of Sopranos being broadcast, the present invention automatically tunes to the X-Files episode being broadcast.

The attribute preferences 410 in data-list 405 can be placed in rank order using any convenient technique. For example, each newly added attribute preference 410 could be added at the top of the data-list 405 and be moved down to its desired ranking using a designated, temporarily re-assigned button, such as the channel-up and channel-down buttons on a remote control device or on the front panel of a television. A viewer may also change the ranking of an attribute preference 410 by, for example, scrolling through the data-list 405 highlighting various attribute preferences until the desired attribute preference 410 is highlighted, selecting the highlighted attribute preference that the viewer wishes to change in the ranking using a selection key, and moving the selected attribute preference as described above.

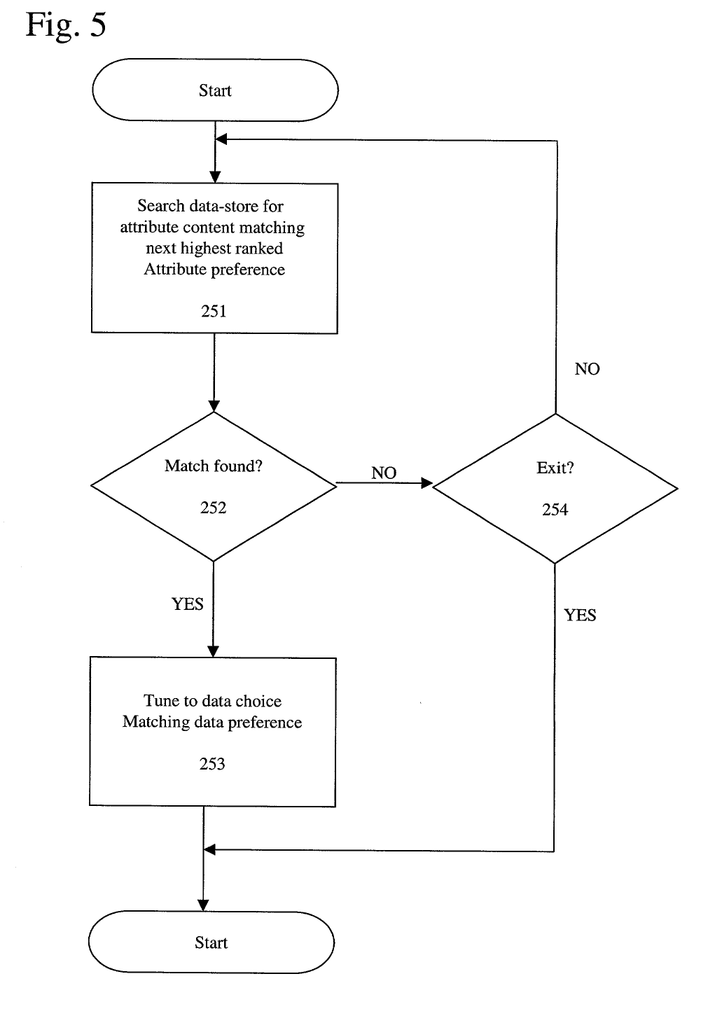

After completing additions and changes to a data-list 405, as shown in FIG. 4, the viewer can select to initiate a second process of the present invention that automatically tunes to a data choice from among a plurality of data choices based on viewer preferences by, for example, selecting an option 420 corresponding to the program of the present invention (i.e., Smart Tune). FIG. 5 is a flow diagram of a process for automatically comparing attribute preferences in a data-list to attribute content in a database in data-store and automatically tuning to a data choice with an attribute content matching the highest ranked attribute preference available. While illustrated and described as a second process, it should be understood that the process for automatically tuning to a data choice based on viewer preferences can be combined with the process for creating a data-list to form a single process.

Referring to FIG. 5, a process executing, for example, on a microprocessor (10 in FIG. 1) searches a data-store (e.g., the data-store represented in the OSD 301 in FIG. 3) of attribute content for available data choices for a match with the highest ranked attribute preference (step 251). For the data-store represented by the OSD illustrated in FIG. 3, the available data choices at 3:45 PM are the programs: Splash, Simpsons, Lake Placid, NHL Hockey, and Blast from the Past. The attribute content includes the titles: Splash 311, Simpsons 312, Lake Placid 314, NHL Hockey 317, and Blast from the Past 319. For the data-list illustrated in FIG. 4, the highest ranked data preference 410 is the show title Sopranos 411. Accordingly, no match will be found for the data preference Sopranos (411 in FIG. 4) in the data-store (301 in FIG. 3). Note that the program title Sopranos 318 is available in the data-store illustrated in FIG. 3 at 4:30 PM, but the process only searches for attribute content for currently available data choices.

The process next determines whether a match has been found (step 252). Each attribute content (310 in FIG. 3) for available data choices is compared to the data preference being searched. If, as in the example described above, no match is found, the process determines whether conditions for exiting the process have been satisfied (step 254). The conditions for exiting the process can be, for example, when each attribute preference (410 in FIG. 4) in the current data-list (405 in FIG. 4) has been searched for in the current data-store (301 in FIG. 3). If the conditions for exiting the process have been satisfied, then the process terminates. The process can include a step (not shown) of automatically restarting at a particular time interval (e.g., at each hour or half-hour, or the end of a currently displayed program). Process termination can result in an action such as tuning to a data choice transmitted at a default frequency or at the most recently viewed frequency.

Referring again to FIG. 5, if, as in the example described above, the conditions for exiting the process have not been satisfied, then the process loops back to step 251. The process then searches the data-store (301 in FIG. 3) of attribute content for available data choices for a match with the next highest attribute preference (step 251). The next highest attribute preference for the data list 405 illustrated in FIG. 4 is X-Files 412. In this example, the process again determines that no match has been found (step 252), and the process again loops back to step 251. On the fifth search (step 251) of the data-store (301 in FIG. 3) for a data content matching the fifth data preference, Simpsons (415 in FIG. 4), the process determines in step 252 that a match has been found. The attribute content of the program title Simpsons (311 in FIG. 3) matches the attribute preference of the program title Simpsons (414 in FIG. 4).

If a match is found in step 252, then the process proceeds to step 253 and automatically controls the tuner (24 in FIG. 1) to tune to the data choice corresponding to the matched attribute content (i.e., the Simpsons program). The signal transmitted at the frequency corresponding to the selected data choice is demodulated by the tuner (24 in FIG. 1), processed and displayed. After the process automatically tunes to the selected data choice, the process terminates.

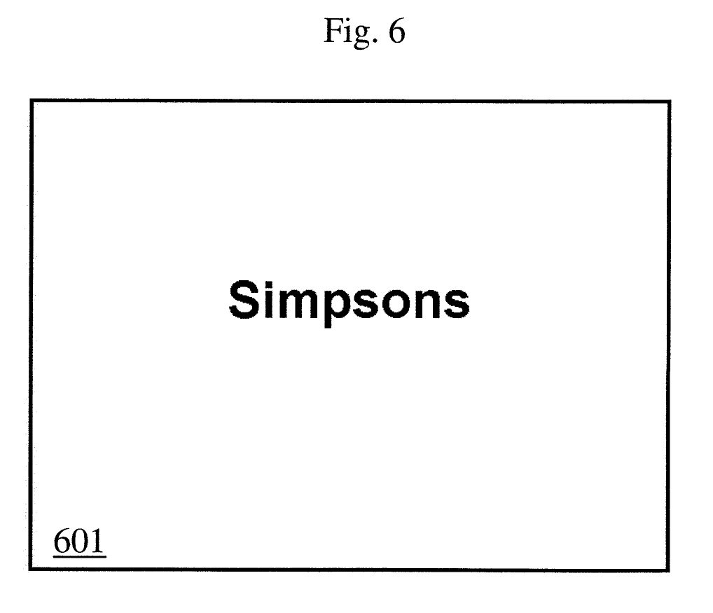

In the exemplary embodiment of the present invention, the selected data choice at 3:45 PM is the program, Simpsons. FIG. 6 illustrates a video display 601 provided by a device (not shown) showing that the program, Simpsons is displayed.

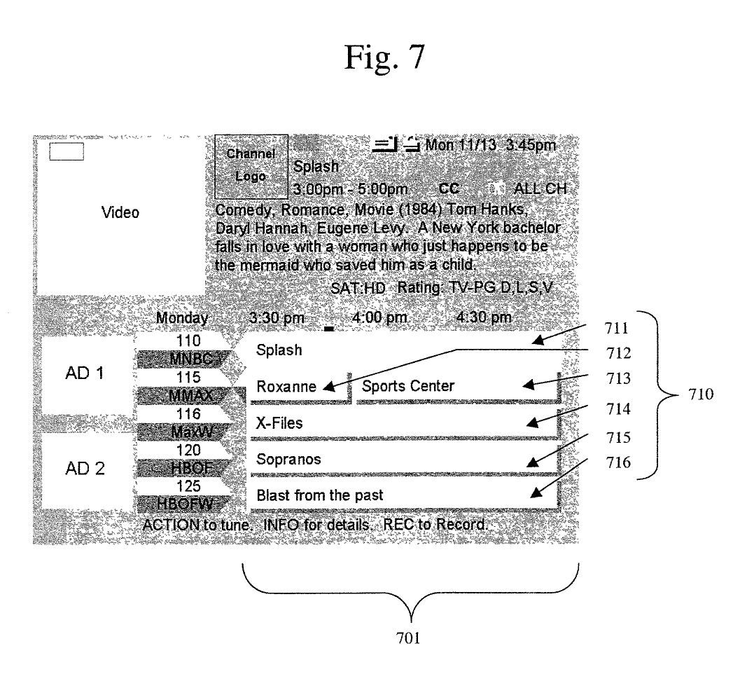

FIG. 7 illustrates the contents of an alternate data-store 701 comprising attribute content 710 of program titles for available programs. The data choices available at 3:45 PM according to the illustrated example are Splash, Roxanne, X-Files, Sopranos and Blast from the Past. The process of the present invention as illustrated in FIG. 5 compares the attribute content 710 for available data choices to the attribute preferences (410 in FIG. 4) of the current data-list (405 in FIG. 4) in rank order (step 251). The attribute content of program title of Sopranos 715 matches the attribute preference of program title of Sopranos (411 in FIG. 4) from the data-list (405 in FIG. 4). In step 252, the process determines that a match has been found, and the process proceeds to step 253 where the tuner (24 in FIG. 1) is tuned to the frequency at which the program, Sopranos is transmitted. The signal containing the program Sopranos is demodulated, processed, and displayed.

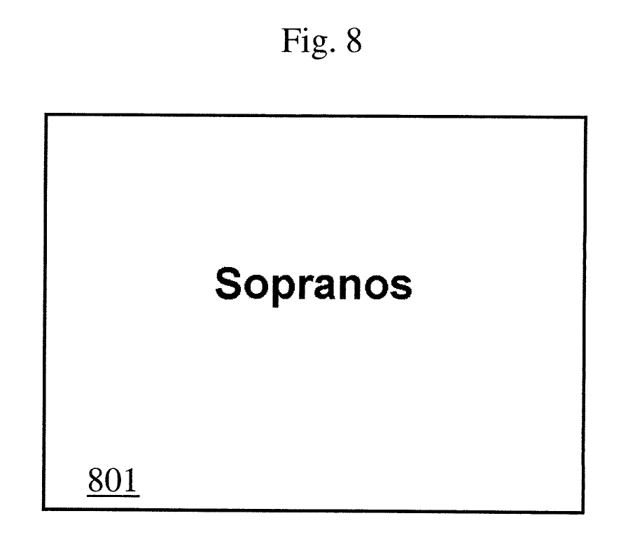

FIG. 8 illustrates the video display 801 provided by a device (not shown) operably connected to the tuner (24 in FIG. 1). The selected data choice from the data-store illustrated in FIG. 7 at 3:45 PM is the program, Sopranos. As illustrated in FIG. 8, the display 801 shows the program, Sopranos. As shown in FIG. 5, following the step of tuning to program Sopranos, the process terminates, and the attribute content matching lower ranked attribute preferences (e.g., 714 in FIG. 7) are not identified or tuned to.

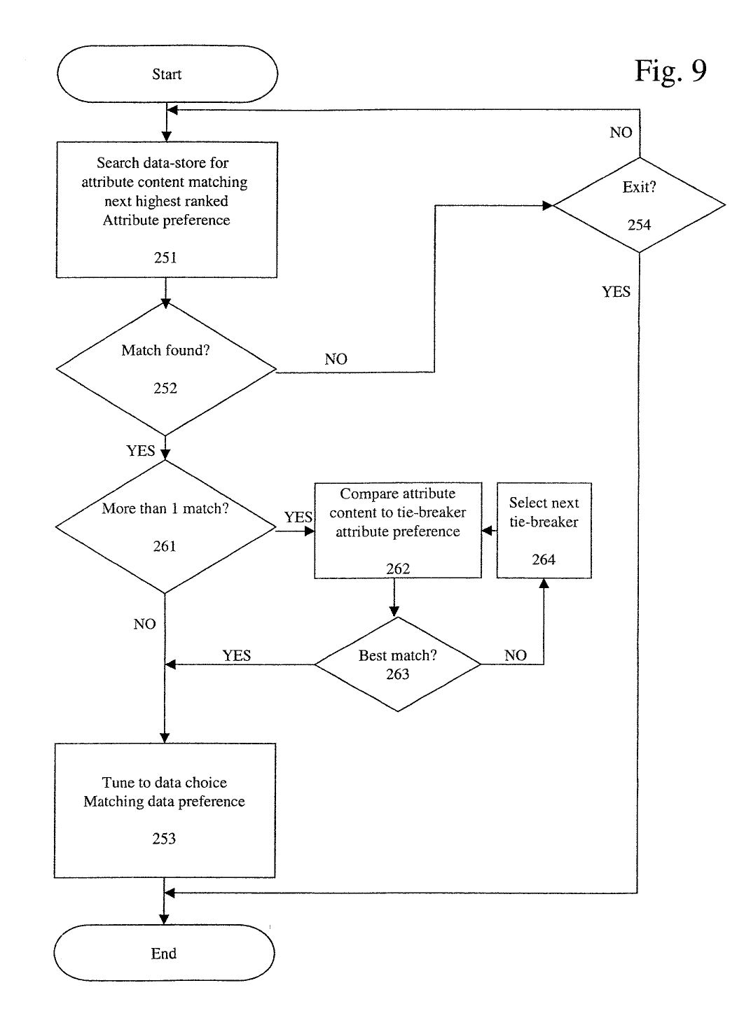

In another aspect of the present invention shown in FIG. 9 a process identifies when more than one data choice has an attribute content that matches the next highest ranking attribute preference, and provides a tie-breaker function. As shown in FIG. 9, the process with a tie-breaker feature is similar to the process illustrated in FIG. 5 and described above with tie-breaking steps added to the flow after determining whether there is a match between attribute content and attribute preference. If the process determines that there is a match (step 252), then it proceeds to step 261 and determines whether there is more than one match for the next highest ranked attribute preference. If there is not more than one match, then the process proceeds to step 253 and tunes to the data choice for the data content matching the next highest ranked data preference.

If the process determines that there is more than one match, however, the process proceeds to step 262. The process compares attribute content for each data choice identified as a match with a tie-breaker attribute preference. For example, the tie breaker attribute could be most recent or latest release date. If, for example, two channels or data choices were transmitting programs with the title Sopranos, and one was from 2000 while the other was from 2001, the episode from 2001 would be tuned to and displayed.

As shown in FIG. 9, after comparing attribute content to a tie-breaker attribute, the process proceeds to step 263 where it determines whether a best match has been found for the tie-breaker attribute. If a best match has been found, then the process proceeds to step 253 and automatically tunes to the best match data choice. If a best match is not found, then the process returns to step 264, in which a next tie-breaker feature is selected and attribute content is compared to a second tie-breaker attribute (step 262).

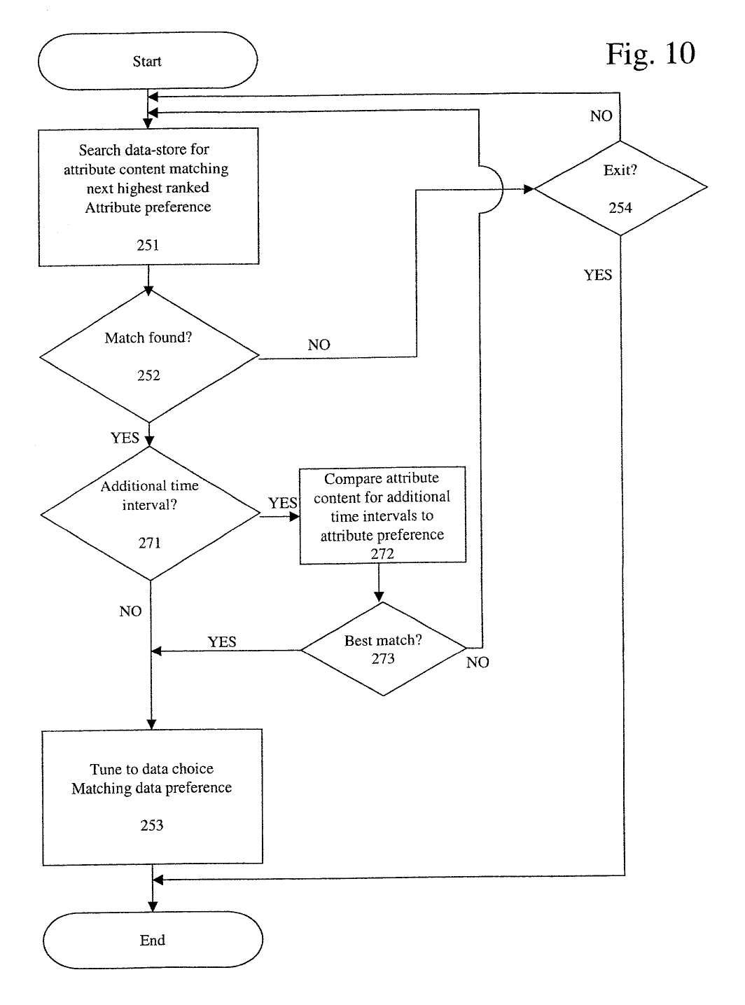

In another aspect of the present invention shown in FIG. 10 a process looks ahead to attribute content for future data choices and blocks out data choices that overlap future data choices with a higher ranked attribute preference. As shown in FIG. 10, the process with a block-out feature is similar to the process illustrated in FIG. 5 and described above with block-out steps added to the flow after determining whether there is a match between attribute content and attribute preference. If the process determines that there is a match (step 252), then it proceeds to step 271 and determines whether the matching data choice is scheduled to overlap additional time intervals. Time intervals are generally standard time periods for presentation of data choices, such as the beginning of each hour and half-hour for television programming. If the matching data choice is not scheduled to overlap additional time intervals, then the process proceeds to step 253 and automatically tunes to the matching data choice. If the matching data choice is scheduled to overlap additional time intervals, then the process proceeds to step 272, and the process compares each higher ranked attribute preference to the attribute content for data choices available in the additional time intervals (step 273). If the matching data choice is still the best match for the additional time intervals, then the process proceeds to step step 253 and automatically tunes to the matching data choice. If the matching data choice is not still the best match for the additional time intervals, then the process proceeds to step step 254 and determines whether conditions for exiting the process have been satisfied (e.g., all attribute preferences have been searched). If not, the process proceeds to step 251 and searches the data-store for a match between the next higher attribute preference and the attribute content for available data choices.

Although the exemplary system is described in terms of a hardware implementation, it is contemplated that some or all of the hardware functionality may be practiced in software running on a data processor of a remote control unit. This software may be embodied in a carrier such as magnetic or optical disk or a radio frequency or audio frequency carrier wave.

It will be understood that various changes in the details, materials, and arrangements of the parts which have been described and illustrated above in order to explain the nature of this invention may be made by those skilled in the art without departing from the principle and scope of the invention as recited in the following claims. For example, the data-store could be provided using an alternate interface, such as the modem illustrated in FIG. 1.

What is claimed:

1. A device for automatically tuning to a user preferred data choice from among a plurality of available data choices, comprising:
an interface for receiving attribute content for a plurality of available data choices; and
a processor configured to execute at least one process, comprising:
means to enable a user to rank attribute preferences in ranked order, means to compare the attribute content with the attribute preferences in ranked order of attribute preferences, identifying at least one attribute of the received attribute content matching a highest ranked attribute preference, and
means to present, automatically, a data choice with the identified attribute content.

2. The device of claim 1, wherein, the at least one process executes again at specific time intervals.

3. The device of claim 1, wherein, the at least one process executes again upon completion of a data choice presentation.

4. The device of claim 1, wherein the data choices are television programs.

5. The device of claim 4, wherein the attribute content comprises at least one of program titles, actors, sports teams, and key words.

6. The device of claim 1 wherein the data choices are radio programs.

7. The device of claim 1 wherein the processor is further configured to compare a tie-breaker attribute preference to attribute content when more than one data choice has the identified attribute content, and automatically present the data choice with attribute content matching the tie-breaker attribute preference.

8. The device of claim 1 wherein the processor is further configured to look ahead to the received attribute content for future data choices and to block out data choices that overlap future data choices with attribute content matching an attribute preference ranked higher than the attribute preference currently matched.

9. The device of claim 1 further comprising a viewer interface, wherein a user can select at least one of a tie-breaker attribute preference for comparing to attribute content to choose between two or more data choices having the identified attribute content and a block-out feature for looking ahead to attribute content for future data choices and blocking out data choices that overlap future data choices with attribute content matching a higher ranked attribute preference than the attribute preference matched by the identified attribute content.

10. The device of claim 1 further comprising a viewer interface and a memory, wherein one or more ranked lists of attribute preferences are created using the viewer interface and stored in the memory and a particular ranked list of attribute preferences is selected using the viewer interface prior to comparing the attribute content with the attribute preferences.

11. A method of automatically tuning to a preferred data choice, comprising the steps of:
creating a ranked list of attribute preferences;
accessing attribute content for each of a plurality of available data choices;
comparing the retrieved attribute content to the ranked list of attribute preferences; and
automatically tuning to the data choice with attribute content matching the highest ranked attribute preference.

12. The method of claim 11 wherein the ranked list of attribute preferences is created by selecting attributes from an attribute database or by entering attribute preferences through a viewer interface.

13. The method of claim 12 wherein the attribute database comprises attribute content over a pre-determined period of time.

14. The method of claim 11 further comprising at the step of:
selecting a tie-breaker attribute preference for comparing to attribute content to choose between two or more data choices having attribute content corresponding to the highest ranked attribute preference with matching attribute content

15. The method of claim 11 further comprising the step of:
setting a block-out feature for looking ahead to attribute content for future data choices and blocking out data choices that overlap future data choices with a higher ranked attribute preference than the highest ranked attribute preference with matching attribute content.

16. A machine readable electronic carrier, having encoded thereon process code, wherein, when the process code is executed by a machine, the machine implements a method for automatically tuning to a preferred data choice from among a plurality of available data choices, the method comprising the steps of:
creating a ranked list of attribute preferences;
accessing attribute content for each of a plurality of available data choices;
comparing attribute content to the ranked list of attribute preferences; and
automatically tuning to the data choice with attribute content corresponding to the highest ranked attribute preference.

17. The machine-readable carrier of claim 16 wherein the ranked list of attribute preferences is created by at least one of selecting attributes from an attribute database and entering attribute preferences through a viewer interface.

18. The machine-readable carrier of claim 16 wherein the method further comprises the step of:
selecting a tie-breaker attribute preference for comparing to attribute content to choose between two or more data choices having attribute content corresponding to the highest ranked attribute preference.

19. The machine-readable carrier of claim 16 wherein the method further comprises the steps of:
setting a block-out feature for looking ahead to attribute content for future data choices and blocking out data choices that overlap future data choices with a higher ranked attribute preference.
